(19) United States
(12) Patent Application Publication
(10) Pub. No.: US 2022/0156698 A1
(43) Pub. Date: May 19, 2022

(54) SYSTEMS, METHODS, AND USER INTERFACES FOR A WEB-BASED PERSONALIZED UPSKILLING PLATFORM INCLUDING VISUALIZING ROLE DATA AND WORKFORCE DATA

(71) Applicant: PricewaterhouseCoopers LLP, New York, NY (US)

(72) Inventors: Suneet DUA, St. Petersburg, FL (US); Darren Terrence LEE, St. Petersburg, FL (US); Sanjay VERMA, Atherton, CA (US); Samant KUMAR, San Jose, CA (US)

(73) Assignee: PricewaterhouseCoopers LLP, New York, NY (US)

(21) Appl. No.: 17/525,649

(22) Filed: Nov. 12, 2021

Related U.S. Application Data
(60) Provisional application No. 63/113,950, filed on Nov. 15, 2020.
(60) Provisional application No. 63/166,770, filed on Mar. 26, 2021.

(51) Int. Cl. G06Q 10/10

(52) U.S. Cl. CPC G06Q 10/105

(57) ABSTRACT

Systems, methods, and graphical user interfaces for visualizing role data and workforce data in an upskilling platform are provided. A system generates data representing associations of a plurality of roles with one or more of a plurality of entities. The system causes display of a graphical user interface comprising display of one or more visualizations representing one or more roles associated with the set of one or more entities. A system may also generate a role profile and cause display of a graphical user interface comprising display of a visualization of the role profile. The visualization of the role profile includes visualizations of one or more skills associated with the role. A system may also generate data representing a comparison of role information at two or more entities. The system causes display of a graphical user interface comprising display of a visualization of the comparison of role information.

### RELATED APPLICATIONS

This application claims benefit to U.S. Provisional Application No. 63/113,950, filed Nov. 15, 2020, and to U.S. Provisional Application No. 63/166,770, filed Mar. 26, 2021, the entire contents of each of which are incorporated herein by reference.

### BACKGROUND

Information about workforce composition, roles of various persons within an organization, and skills of various persons within organizations can offer valuable insights for members of said organizations, competitors, analysts, investors, hiring managers, and job applicants. For example, members of an organization may use role data to inform hiring practices, to aid in the professional development of employees of the organization, or to cultivate business intelligence about partner organizations and competitor organizations.

### SUMMARY

As described above, information about workforce composition, roles of various persons within an organization, and skills of various persons within organizations can offer valuable insights. However, data sets providing said information can be very large and complex, can be distributed across disparate systems, and can be formatted inconsistently. Thus, these data sets can be cumbersome, inconvenient, time-consuming, inefficient, and inaccurate to process according to known methods, which rely on manual ingestion, organization, and processing of data.

Accordingly, there is a need for improved systems and methods for ingesting, formatting, organizing, processing, and analyzing information about workforce composition, roles of various persons within an organization, and skills of various persons within organizations. In particular, there is a need for performing said methods in an efficient and automated (or semi-automated) manner, and for providing intuitive and accessible graphical user interfaces that allow users in various different roles to interact with the ingested data, edit the ingested data, and generate and interact with interactive visualizations based on said ingested data. Disclosed herein are systems, methods, and graphical user interfaces that may address one or more of the above-identified needs.

In some embodiments, improved systems, methods, and graphical user interfaces for ingesting, processing, and visualizing data about role data and skill data of various members of organizations, as contemplated by the needs explained above, may be provided as a part of a web-based personalized upskilling platform.

An upskilling platform may be usable by enterprises or by other large organizations to provide various functionalities in connection with skills of users of the system, including, for example, generating and visualizing insights regarding various organizations and users, and/or providing and managing consumption of upskilling content (e.g., media content objects such as videos, articles, quizzes, courses, etc.) to employees or other members of the organization. (While the disclosure herein provides examples in the context of organizations in which users are employees, upskilling platforms such as those described herein may be used by organization in which users are employees, members, subscribers, students, etc.) In some embodiments, an upskilling platform, such as those described herein, may be configured to automatically (e.g., periodically or in response to a trigger condition being satisfied) ingest data representing a plurality of organizations (e.g., companies, non-profit organizations, enterprises, educational institutions, etc.). The data may be ingested from a plurality of data sources including but not limited to, e.g., job listing data describing job openings and required/desired skills and experience for applicants for the particular role, job description data describing a current employee's role within an organization and/or the employee's skills and experience, and/or social media information in which an employee describes their role within an organization and/or skills and experience. In some embodiments, the system may also ingest data that is provided manually by a user (such as an administrator at an organization); for example, an organization may provide an organizational chart, employee roster, job information data, and/or employee information data.

The ingested data may be cleaned and formatted for storage in one or more databases of the system. In some embodiments, the data may be wholly or partially anonymized (or an anonymized version of the data may be created). In some embodiments, one or more automated algorithms (e.g., machine learning algorithms) may be applied to the ingested data in order to generate data to characterize an organization, a role within the organization, and/or one or more skills associated with a role within an organization.

In some embodiments, one or more algorithms (e.g., machine learning algorithms) may be used to determine skill data (e.g., skills, current skill levels, target skill levels, skill prominence, skill importance) for one or more roles, one or more users, and/or one or more organizations. Algorithmic determination of skill data may in some embodiments be based, at least in part, on analysis of data and/or metadata associated with role data, organization data, and/or user data. Data analyzed may include information included in the text of a job listing, role description, user biography page, company biography page or the like. Metadata analyzed may include information regarding how long a job posting or other data has been posted or otherwise available, how many views a webpage has received, how many applicants a job posting has received, how many views a job posting has received, a volume of interaction by users or members of the public with a webpage or other data source, the identity or role of one or more persons who have interacted with a webpage or other data source, and/or a degree of closeness (e.g., using graph analysis) of relation between a data source and a role, user, or organization for whom skill data is being determined. Similar algorithms (considering similar data types and metadata types) may in some embodiments be used to analyze received data to determine skill data for a piece of upskilling content (e.g., a media content object).

Once data regarding one or more organizations is ingested, the system may then provide one or more user interfaces for using that data to visualize insights about organizations, employees or other members within those organizations, roles and role types (e.g., job titles) within those organizations, and/or skills or specific employees or associated with specific job types within one or more of those organizations. In some embodiments, the system can organize and/or display information at the level of an individual organization, a set of organizations, or an industry or sector.

In some embodiments, a user of the platform may use the graphical user interface to execute one or more inputs causing the system to visualize the ingested information for one or more sectors, industries, organizations, roles, employees, and/or skills. For example, the user may execute an input indicating one or more organizations, and the system may responsively visualize data showing the distribution of roles within the organization(s), distribution and importance of one or more skills within the organization(s), and/or changes over time to any of the above. In some embodiments, the system may responsively visualize data showing a comparison of roles and/or skills between different organizations, such as by showing a quantification of a ratio of roles or skills between two different organizations or between an organization and a sector. In some embodiments, the user may execute an input indicating one or more roles (e.g., one or more job titles or job types), and the system may responsively visualize data representing the nature of the role at one or more organizations. For example, the system may visualize the skills associated with a role (and the relative importance of the respective skills) at a specific organization or in a defined industry or sector. In some embodiments, the system may automatically determine what roles and/or skills to visualize based on a user's selection of one or more organizations.

In some embodiments, visualizations generated and displayed by the system may include a visualization of one or more temporal changes in roles for an organization or industry or sector, a visualization of top emerging roles for an industry or sector, a visualization of top declining roles for an industry or sector; and/or a visualization of a comparison of role prevalence between a first set of one or more organizations and a second set of one or more organizations. In some embodiments, visualizations generated and displayed by the system may include a visualization of one or more temporal changes in skills for an organization or industry or sector, a visualization of top emerging skills for an industry or sector, a visualization of top declining skills for an industry or sector; and a visualization of a comparison of skill prevalence between a first set of one or more organizations and a second set of one or more organizations.

In some embodiments, the system may be configured such that a user is enabled to “drill down” on one or more of the displayed visualizations, such as by clicking on or hovering a mouse over a displayed visualization in order to cause additional related information to be displayed and/or to cause the indicated information to be displayed in a different format and/or at a higher precision.

Visualizing role and skill data for various organizations may allow for users of the graphical user interface to glean insights about role gaps and skill gaps at their own organizations (e.g., by comparing to peer organization, market leaders, or industry/sector averages), which may allow organizations to make intelligent and effective choices regarding hiring choices and upskilling of existing employees. In some embodiments, a user of the platform may be able to use the visualized insights to drive decisions regarding which upskilling content to deliver to employees via the platform, and/or to drive decisions regarding how and from whom to solicit digital assets or automations via the platform.

In some embodiments, a first system, for visualizing role data, is provided, the first system comprising one or more processors configured to cause the system to: receive a data set comprising a plurality of role descriptions; generate, based on the data set, data representing associations of a plurality of roles indicated by the plurality of role descriptions with one or more of a plurality of entities; cause display of a graphical user interface comprising a visualization region; receive, via the graphical user interface, a first user input comprising an instruction to visualize role information for a set of one or more of the entities, wherein the first user input comprises an indication of the set of one or more of the entities; and, in response to receiving the first input, generate and cause display in the display region, based on the data representing the associations of a plurality of roles indicated by the plurality of role descriptions with one or more of a plurality of entities, of one or more visualizations representing one or more roles associated with the set of one or more of the entities.

In some embodiments of the first system, receiving the data set comprises receiving data from one or more sources selected from: a job posting data source; a job description data source, a data source associated with a single entity of the plurality of entities; a data source associated with more than one of the plurality of entities; and a social media data source.

In some embodiments of the first system, receiving the data set comprises one or more methods of receipt selected from: performing automated scraping of one or more data sources, receiving a batch upload; receiving the data set according to a predetermined schedule; receiving the data set in response to a predefined trigger condition; and receiving an update to previously-received data.

In some embodiments of the first system, wherein generating the data representing the associations of the plurality of roles with one or more of the plurality of entities comprises applying one or more automated algorithms.

In some embodiments of the first system, the indication of the set of one or more entities comprises an indication of one or more selected from: an entity associated with the first user, an entity not associated with the first user, and an industry sector.

In some embodiments of the first system, the one or more visualizations representing one or more roles associated with the set of one or more of the entities comprise one or more visualizations selected from the following: a visualization of one or more temporal changes in roles for the set of one or more entities, a visualization of top emerging roles for the set of one or more entities, a visualization of top declining roles for the set of one or more entities, and a visualization of a comparison of role prevalence between a first subset of one or more entities in the set of entities and a second subset of one or more entities in the set of entities.

In some embodiments of the first system, display of the visualization of the comparison of role prevalence comprises display of a first portion visualizing a first role quantification associated with the first subset of entities, a second portion visualizing a second role quantification associated with the second subset of entities, and a third portion visualizing a first comparison quantification of a difference between the first role quantification and the second role quantification.

In some embodiments of the first system, the first portion comprises a first ring diagram indicating a first role percentage, the second portion comprises a second ring diagram indicating a second role percentage, and the third portion comprises an indication of a multiple comparing the first role percentage and the second role percentage, wherein the third portion is displayed in an interior space of the first ring diagram and the second ring diagram.

In some embodiments of the first system, the one or more processors are configured to cause the first system to detect a second user input comprising an indication of the first portion and, in response to detecting the second user input, update the first portion to increase a displayed precision of the first role quantification.

In some embodiments of the first system, the one or more roles are automatically selected by the first system for visualization based on the indication of the set of one or more of the entities via the first user input.

In some embodiments of the first system, one or more of the plurality of role descriptions comprises an indication of a plurality of skills, and the one or more processors are further configured to cause the first system to: generate, based on the data set, data representing associations of the plurality of skills with one or more of the plurality of entities; receive, via the graphical user interface, a third user input comprising an instruction to visualize skill information for the set of one or more of the entities, wherein the third user input comprises an indication of the set of one or more of the entities; and, in response to receiving the third user input, generate and cause display in the display region, based on the data representing the associations of the plurality of skills with one or more of the plurality of entities, of one or more visualizations representing one or more skills associated with the set of one or more of the entities.

In some embodiments of the first system, the one or more visualizations representing one or more skills associated with the set of one or more of the entities comprise one or more visualizations selected from the following: a visualization of one or more temporal changes in skills for the set of one or more entities, a visualization of top emerging skills for the set of one or more entities, a visualization of top declining skills for the set of one or more entities, and a visualization of a comparison of skill prevalence between a third subset of one or more entities in the set of entities and a fourth subset of one or more entities in the set of entities.

In some embodiments of the first system, display of the visualization of the comparison of skill prevalence comprises display of a fourth portion visualizing a first skill quantification associated with the third subset of entities, a fifth portion visualizing a second skill quantification associated with the fourth subset of entities, and a sixth portion visualizing a second comparison quantification of a difference between the first skill quantification and the second skill quantification.

In some embodiments of the first system, the fourth portion comprises a third ring diagram indicating a first skill percentage, the fifth portion comprises a fourth ring diagram indicating a second skill percentage, the sixth portion comprises an indication of a multiple comparing the first skill percentage and the second skill percentage, and the sixth portion is displayed in an interior space of the third ring diagram and the fourth ring diagram.

In some embodiments of the first system, the one or more processors are configured to cause the first system to detect a fourth user input comprising an indication of the fourth portion and, in response to detecting the fourth user input, update the fourth portion to increase a displayed precision of the first skill quantification.

In some embodiments of the first system, the one or more skills are automatically selected by the system for visualization based on the indication of the set of one or more of the entities via the first user input.

In some embodiments, a first method, for visualizing role data, is provided. The first method is performed at a system comprising one or more processors. The first method comprises: receiving a data set comprising a plurality of role descriptions; generating, based on the data set, data representing associations of a plurality of roles indicated by the plurality of role descriptions with one or more of a plurality of entities; causing display of a graphical user interface comprising a visualization region; receiving, via the graphical user interface, a first user input comprising an instruction to visualize role information for a set of one or more of the entities, wherein the first user input comprises an indication of the set of one or more of the entities; and, in response to receiving the first input, generating and causing display in the display region, based on the data representing the associations of a plurality of roles indicated by the plurality of role descriptions with one or more of a plurality of entities, of one or more visualizations representing one or more roles associated with the set of one or more of the entities.

In some embodiments, a first non-transitory computer-readable storage medium, storing instructions for visualizing role data, is provided, the instructions executable by a system comprising one or more processors to cause the system to: receive a data set comprising a plurality of role descriptions; generate, based on the data set, data representing associations of a plurality of roles indicated by the plurality of role descriptions with one or more of a plurality of entities; cause display of a graphical user interface comprising a visualization region; receive, via the graphical user interface, a first user input comprising an instruction to visualize role information for a set of one or more of the entities, wherein the first user input comprises an indication of the set of one or more of the entities; and, in response to receiving the first input, generate and cause display in the display region, based on the data representing the associations of a plurality of roles indicated by the plurality of role descriptions with one or more of a plurality of entities, of one or more visualizations representing one or more roles associated with the set of one or more of the entities.

In some embodiments, a second system, for providing a role library, is provided, the second system comprising one or more processors configured to cause the second system to: receive a data set comprising a plurality of role descriptions, wherein one or more of the plurality of role descriptions comprises an indication of one or more skills; generate, based on the data set, a role profile for a role, the role profile comprising data indicating an association of a plurality of skills associated with the role; cause display a of graphical user interface comprising a visualization region; receive, via the graphical user interface, a first user input comprising an instruction to visualize the role profile; and in response to receiving the first input, cause display in the display region of a visualization of the role profile comprising a visualization of the plurality of skills.

In some embodiments of the second system, receiving the data set comprises receiving data from one or more sources selected from: a job posting data source, a job description data source, a data source associated with a single entity of the plurality of entities, a data source associated with more than one of the plurality of entities, and a social media data source.

In some embodiments of the second system, receiving the data set comprises one or more methods of receipt selected from: performing automated scraping of one or more data sources, receiving a batch upload, receiving the data set according to a predetermined schedule, receiving the data set in response to a predefined trigger condition, and receiving an update to previously-received data.

In some embodiments of the second system, generating the role profile comprises applying one or more automated algorithms.

In some embodiments of the second system, the instruction to visualize the role profile comprises one or more selected from: typing of the name of the role, selection of a user-interface affordance associated with the role, and selection of the role via a menu of a role library.

In some embodiments of the second system, the role profile comprises data quantifying an importance of one or more of the plurality of skills associated with the role, and the visualization of the role profile comprises a visualization of the data quantifying the importance of the one or more of the plurality of skills associated with the role.

In some embodiments of the second system, the one or more of the plurality of skills are automatically selected by the system for visualization based on the data set comprising the plurality of role descriptions.

In some embodiments of the second system, the visualization comprises display of a subset of skills that are determined to be most important to the role.

In some embodiments of the second system, the one or more processors are further configured to cause the second system to receive, via the graphical user interface, a second user input comprising an instruction to modify the role profile and, in response to receiving the second input, modify the role profile in accordance with the instruction to modify the role profile and update the visualization of the role profile in accordance with the modification.

In some embodiments of the second system, the instruction to modify the role profile comprises an instruction to modify skills associates with the role by performing one or more of the following: adding a new skill to the role profile, removing a skill from the role profile, and modifying data quantifying an importance of a skill in the role profile.

In some embodiments, a second method, for providing a role library, is provided. The second method is performed at a system comprising one or more processors. The second method comprises: receiving a data set comprising a plurality of role descriptions, wherein one or more of the plurality of role descriptions comprises an indication of one or more skills; generating, based on the data set, a role profile for a role, the role profile comprising data indicating an association of a plurality of skills associated with the role; causing display a of graphical user interface comprising a visualization region; receiving, via the graphical user interface, a first user input comprising an instruction to visualize the role profile; and, in response to receiving the first input, causing display in the display region of a visualization of the role profile comprising a visualization of the plurality of skills.

In some embodiments, a second non-transitory computer-readable storage medium, storing instructions for providing a role library, is provided, wherein the instructions are executable by a system comprising one or more processors to cause the system to: receive a data set comprising a plurality of role descriptions, wherein one or more of the plurality of role descriptions comprises an indication of one or more skills; generate, based on the data set, a role profile for a role, the role profile comprising data indicating an association of a plurality of skills associated with the role; causing display a of graphical user interface comprising a visualization region; receive, via the graphical user interface, a first user input comprising an instruction to visualize the role profile; and, in response to receiving the first input, cause display in the display region of a visualization of the role profile comprising a visualization of the plurality of skills.

In some embodiments, a third system, for visualizing workforce data, is provided, the third system comprising one or more processors configured to cause the third system to: receive a first data set comprising an indication of a first plurality of roles associated with a first organization; receive a second data set comprising an indication of a second plurality of roles associated with a second organization; cause display of a graphical user interface comprising a visualization region; receive, via the graphical user interface, a first user input comprising an instruction to visualize a comparison of role information between the first organization and the second organization, wherein the instruction comprises an indication of a first role at the first organization and an indication of a second role at the second organization; and, in response to receiving the first input, generate and cause display in the display region, based on the first data set and the second data set, of a visualization of the comparison of role information between the first organization and the second organization.

In some embodiments of the third system, receiving the first data set comprising the indication of the first plurality of roles associated with the first organization comprises one or more methods of receipt selected from: receiving an organizational chart representing the first organization, ingesting job-posting data pertaining to the first organization, ingesting job-description data pertaining to the first organization, and ingesting social media information associated with the first organization.

In some embodiments of the third system, receiving the second data set comprising the indication of the second plurality of roles associated with the second organization comprises one or more methods of receipt selected from: receiving an organizational chart representing the second organization, ingesting job-posting data pertaining to the second organization, ingesting job-description data pertaining to the second organization, and ingesting social media information associated with the second organization.

In some embodiments of the third system, the first role at the first organization and the second role at the second organization are each associated with a common role profile.

In some embodiments of the third system, the first role at the first organization and the second role at the second organization are not associated with a common role profile.

In some embodiments of the third system, the first data set and the second data set comprise information indicating respective skills associated with one or more of the roles of the first and second pluralities of roles, and the visualization represents a comparison of a first set of skills associated with the first role in the first organization against a second set of skills associated with the second role in the second organization.

In some embodiments of the third system, the visualization indicates a first quantification of a first importance of one or more of the skills of the first set of skills and a second quantification of a second importance of one or more of the skills of the second set of skills.

In some embodiments of the third system, the third system is further configured to determine a display order for one or more of the first set of skills and the second set of skills based on one or more of the first quantification of the first importance and the second quantification of the second importance.

In some embodiments of the third system, the third system is configured to select one or more of the first set of skills and the second set of skills for display based on one or more of the first quantification of the first importance and the second quantification of the second importance.

In some embodiments of the third system, the third system selects skills for visualization based on a difference between the first quantification of the first importance and the second quantification of the second importance.

In some embodiments of the third system, the visualization aligns representations of matching skills across the first set of skills in the second set of skills with one another.

In some embodiments, a third method, for visualizing workforce data, is provided. The third method is performed at a system comprising one or more processors. The third method comprises: receiving a first data set comprising an indication of a first plurality of roles associated with a first organization; receiving a second data set comprising an indication of a second plurality of roles associated with a second organization; causing display of a graphical user interface comprising a visualization region; receiving, via the graphical user interface, a first user input comprising an instruction to visualize a comparison of role information between the first organization and the second organization, wherein the instruction comprises an indication of a first role at the first organization and an indication of a second role at the second organization; and, in response to receiving the first input, generating and causing display in the display region, based on the first data set and the second data set, of a visualization of the comparison of role information between the first organization and the second organization.

In some embodiments, a third non-transitory computer-readable medium, storing instructions for visualizing workforce data, is provided, wherein instructions are executable by a system comprising one or more processors to cause the system to: receive a first data set comprising an indication of a first plurality of roles associated with a first organization; receive a second data set comprising an indication of a second plurality of roles associated with a second organization; cause display of a graphical user interface comprising a visualization region; receive, via the graphical user interface, a first user input comprising an instruction to visualize a comparison of role information between the first organization and the second organization, wherein the instruction comprises an indication of a first role at the first organization and an indication of a second role at the second organization; and in response to receiving the first input, generate and cause display in the display region, based on the first data set and the second data set, of a visualization of the comparison of role information between the first organization and the second organization.

In some embodiments, any of the above systems, methods, and computer-readable storage media may be combined, in whole or in part, with one another, and/or with any other features disclosed herein.

### BRIEF DESCRIPTION OF THE DRAWINGS

FIG. 1 shows a system providing a personalized web-based upskilling and digital asset management platform, according to some embodiments.

FIG. 2 shows a method for visualizing role data and workforce data, according to some embodiments.

FIG. 3A shows a graphical user interface screen displaying a visualization of the top emerging and declining roles within an industry, according to some embodiments.

FIG. 3B shows a portion of a graphical user interface screen displaying a ring diagram for visualizing role prevalence, according to some embodiments.

FIG. 4 shows a method for generating and displaying role profiles in a role library, according to some embodiments.

FIG. 5 shows a graphical user interface screen displaying a visualization of role profiles in a role library, according to some embodiments.

FIG. 6 shows a method for visualizing role data for multiple entities, according to some embodiments.

FIG. 7 shows a graphical user interface screen displaying visualizations of role data for multiple entities, according to some embodiments.

FIG. 8 shows a computer, in accordance with some embodiments.

### DETAILED DESCRIPTION

Reference will now be made in detail to various embodiments, examples of which are illustrated in the accompanying drawings. Wherever possible, the same reference numbers will be used throughout the drawings to refer to the same or like parts. Moreover, use of the indefinite article “a” or “an” in the specification and the claims is meant to include one or more of the feature that it introduces, unless otherwise indicated.

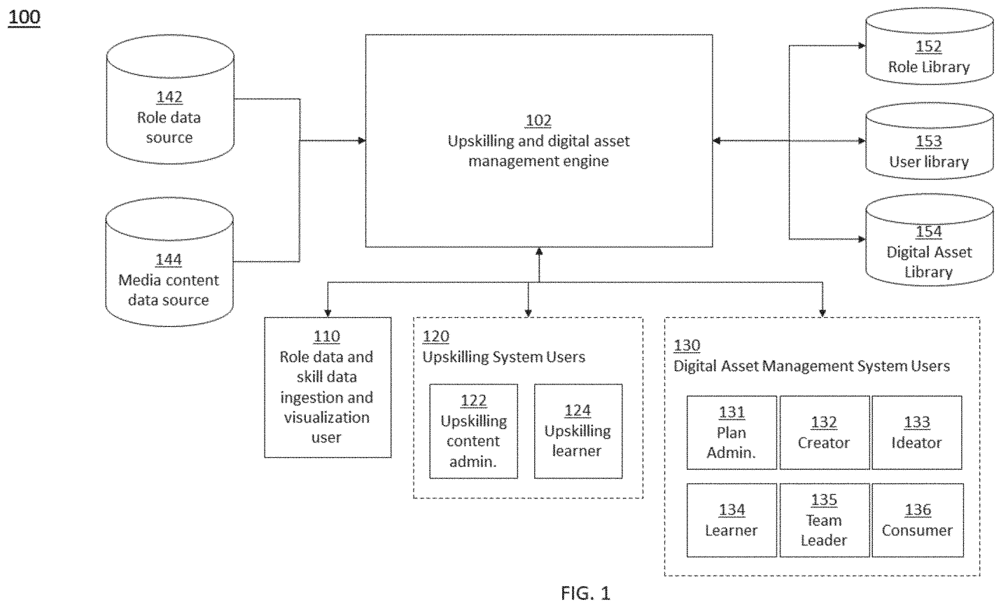

FIG. 1 shows a system 100 providing a personalized web-based upskilling and digital asset management platform, according to some embodiments. As shown, system 100 comprises a central upskilling and digital asset management engine 102 configured to communicate (e.g., via wired or wireless electronic communication) with a plurality of user devices, data sources, and libraries. Upskilling and digital asset management engine 102 may comprise one or more processors. Users of system 100 may include a role data and skill data ingestion and visualization user 110, upskilling system users 120, and digital asset management system users 130. Data sources include role data source 143 and media content data source 144. Libraries include role library 152, user library 153, and digital asset library 154.

As described herein, various users of system 100 may be associated with different roles, different permissions, and/or different associated graphical user interface screens. Furthermore, users may be associated with user-specific profiles (e.g., stored information associate with the user) that indicates the user's role, the user's permissions, and/or the user's skills and skill levels. The users depicted in FIG. 1 are exemplary, and in some embodiments system 100 may include additional users of other user types/roles. In some embodiments, a single user may interact with system 100 in more than one of the user roles/types contemplated by FIG. 1. As shown in FIG. 1, users of system 100 may include:
Role data and skill data ingestion and visualization user 110, who may interact with one or more user interface screens configured to allow the user to control ingestion of role data and skill data and to generate one or more visualizations representing roles within an organization, skills of members of an organization, skills of certain role types, skills of specific users/employees, comparisons of different organizations, and/or comparisons of different users;
Upskilling content administrator 122, who may interact with one or more user interface screens configured to allow the user to manage creation and/or modification of user profiles for upskilling learners (e.g., profiles for employees who will consume upskilling media content), creation and/or modification of role profiles, ingestion of upskilling media content, and/or creation of data associating upskilling media content with one or more role profiles and/or one or more user profiles;
Upskilling learner 124, who may interact with one or more user interface screens configured to allow the user to consume upskilling content (e.g., upskilling media content) in order to obtain additional skills and/or to increase skill levels for existing skills;
Plan administrator 131, who may interact with one or more user interface screens configured to allow the user to review digital asset submissions, determine one or more users to whom digital assets and/or upskilling content are submitted, and/or determine a manner in which one or more digital assets and/or upskilling content are distributed amongst users;
Creator 132, who may interact with one or more user interface screens configured to allow the user to create and upload a digital asset submission, optionally including digital asset code and associated metadata;
Ideator 133, who may interact with one or more user interface screens configured to allow the user to create and upload a digital asset solicitation (e.g., an “idea”);
Learner 134, who may interact with one or more user interface screens configured to allow the user to consume upskilling content (e.g., upskilling media content) and/or digital assets in order to obtain additional skills and/or to increase skill levels for existing skills;
Team leader 135, who may interact with one or more user interface screens configured to allow the user to review digital asset submissions, determine one or more users to whom digital assets and/or upskilling content are submitted, and/or determine a manner in which one or more digital assets and/or upskilling content are distributed amongst users; and
Consumer 136, who may interact with one or more user interface screens configured to allow the user to view, review, implement, test, rate, “like,” and/or submit feedback for one or more digital assets.

Upskilling and digital asset management engine 102 may communicate with the plurality of users by transferring data to and/or receiving data from a plurality of user devices belonging to said plurality of users. In some embodiments, user devices may include desktop computers, laptops, smart phones, and/or tablets. In some embodiments, upskilling and digital asset management engine 102 may cause one or more graphical user interface (GUI) screens to display on the display of a user device. Depending on the user, the one or more GUI screens may be configured to display information and/or receive user input related to role data ingestion and visualization, skill data ingestion and visualization, upskilling, and/or digital asset management.

In some embodiments, upskilling and digital asset management engine 102 may receive data representing a plurality of organizations. Organizations may include companies, non-profit organizations, enterprises, educational institutions, and the like. Upskilling and digital asset management engine 102 may ingest data representing roles (e.g., employee positions) within an organization from role data source 142. In some embodiments, role data source 142 may include one or more data sources for job listings and/or job descriptions, such as company websites, social media and/or professional networking websites (e.g., LinkedIn) and/or such as job listing websites. Role data received from role data source 142 may include job listing data describing job openings and required/desired skills and experience for applicants for the particular role, job description data describing a current employee's role within an organization and/or the employee's skills and experience, social media information in which an employee describes their role within an organization and/or skills and experience, organizational charts for one or more organizations, employee rosters for one or more organizations, job information data relating to one or more organizations, and/or employee information data relating to one or more organizations.

In some embodiments, upskilling and digital asset management engine 102 may be configured to generate one or more role profiles based on role data received from role data source 142. A role profile may comprise data describing the required and/or desired skills and experience necessary to fulfill a corresponding role within an organization. In some embodiments, role profiles may be specifically configured for one organization (or a set of organizations); in some embodiments, role profiles may be configured generally for all organizations using system 100. Role profiles may be stored by system 100 in role library 152, which may include and/or provide any suitable electronic storage systems (e.g., databases).

In some embodiments, in addition to role profiles stored in role library 152, system 100 may include user profiles stored in user library 153. While role profiles may indicate information regarding average (and/or optimal) skills and skill levels for a certain role type, a user profile may include user information—including role information, skill type information, and skill level information—for a specific user. Information stored regarding a specific user may include user identification information, the user's organization, the user's position within the organization's structure, one or more roles of the user within the organization, and an indication of what skills (and associated skill levels) the user possesses. In some embodiments, user profiles, role information for a user, and skill information for a user may be automatically ingested and/or extracted from one or more data sets provided to system 100, and/or may be explicitly indicated by one or more users of system 100 creating and/or configuring user profiles. Thus, upskilling and digital asset management engine 102 may have access to information regarding the current skills and skill levels of employees within an organization, as well as the target skills and skill levels for users having that role. One or more system operations may be carried out in accordance with skill gaps (e.g., skill deltas) representing a difference between a user's current skill levels and target skill levels for that user's role or roles.

Upskilling and digital asset management engine 102 may be configured to increase or decrease a skill level of a skill for an employee upon receipt of certain data (e.g., data indicating that an employee has consumed upskilling content, or indicating that a user has created, implemented, and/or consumed a digital asset). In some embodiments, users (e.g., organization administrators) of system 100 may manually review, approve, and/or modify skill levels and/or skill level adjustments for users.

Upskilling and digital asset management engine 102 may ingest data representing media content from media content data source 144. In some embodiments, media content may include upskilling content and may comprise articles, videos, essays, podcasts, quizzes, and/or interactive courses. In some embodiments, media content data source 144 may include one or more external sources of educational courses (e.g., a university website, a commercial educational content source, etc.), websites for hosting videos (e.g., YouTube), academic journals, magazines, newspapers, and/or social media sites (e.g., LinkedIn). In some embodiments, upskilling and digital asset management engine 102 may be configured to link role profiles with ingested media content related to the role. For example, engine 102 may generate metadata associating specific courses or other media content with a certain role profile, such that the indicated media content may serve as upskilling content for users of the indicated role. When users consume the indicated media content, engine 102 may then automatically cause the user's skill levels to increase by an amount indicated by metadata associated with the media content and/or with the role profile for the user's role. In some embodiments, upskilling and digital asset management engine 102 may transmit ingested media content data to digital asset library 154 for storage, optionally in association with metadata relating to upskilling via the indicated media content.

In some embodiments, system 100 (or a similar web-based upskilling system) may be configured to execute methods for visualizing role data and/or workforce data. For example, system 100 may receive role data (e.g., from role data source 142) including information about roles and associated skills for one or more specific users, for one or more generic role types, and/or for one or more organizations or entities (e.g., companies). The system may then use said received data to generate one or more visualizations (e.g., interactive visualizations) for display on and interaction via one or more graphical user interfaces. A system user (e.g., role data and skill data ingestion and visualization user 110) may interact with one or more screens of a graphical user interface in order to execute inputs to control the manner in which the system ingests role data, processes ingested role data, and/or generates and displays visualizations of role and skill data for one or more users, roles, and/or entities.

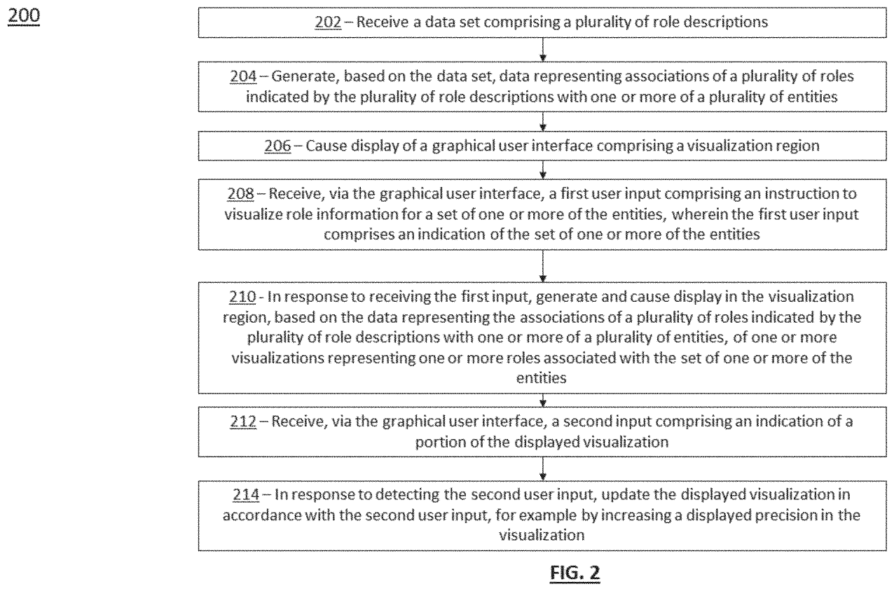

FIG. 2 shows a method 200 for visualizing role data and workforce data, according to some embodiments. Method 200 may be executed by one or more processors included in a system for upskilling and digital asset management, for example by system 100 (e.g., by upskilling and digital asset management engine 102) described above with reference to FIG. 1.

In some embodiments, at block 202, the system may receive a data set comprising a plurality of role descriptions. Receiving the data set may comprise one or more methods of receipt, including: performing automated scraping of one or more data sources; receiving a batch upload; receiving the data set according to a predetermined schedule; receiving the data set in response to a predefined trigger condition; and/or receiving an update to previously received data. The data set may comprise information ingested by the system from a job description data source, a job posting data source, a data source associated with one or more organizations (e.g., a company website), a social media data source (e.g., LinkedIn), and/or a user. In some embodiments, the data set may comprise pre-curated and/or pre-formatted job-listing data (e.g., as received from one or more sources of aggregated job-listing data), in place of or in addition to raw job listing data (e.g., as received from one or more job listings).

The role description data may include information indicating that certain roles (e.g., job titles, positions) are or are not present within certain entities. The role description data may indicate the identities of persons who hold one or more roles, and the entity within which those persons hold said roles. The role description data may indicate skills (including skill levels and/or skill importance) associated with certain roles, for example in the form of required or preferred skills associated with a job listing for a role, or associated with a job description of a role on a company website. The role description data may indicate skills (including skill levels and/or skill importance) associated with a specific person holding a role at a given entity, for example in the form of a description of a person's skills or experiences (e.g., on a bio page for an employee on a company website, on a person's resume of CV, or on a person's social media page). In some embodiments, the system may be configured to augment and/or modify skill information based on a manual review of a job description data source, a job posting data source, a data source associated with one or more organizations, and/or a social media data source.

Received role description data may be stored by the system on any suitable electronic storage medium, such as by being stored on and/or in association with a database of role library 152.

At block 204, in some embodiments, the system may generate, based on the data set, data representing associations of a plurality of roles indicated by the plurality of role descriptions with one or more of a plurality of entities. As used herein, an “entity” may be an organization such as, for example, a company, a non-profit organization, an educational institution, or an enterprise. In some embodiments, the role description data may explicitly indicate one or more skills (or skill levels) for a role. In some embodiments, the role description data may implicitly indicate one or more skills (or skill levels) for a role, and the system may apply one or more algorithms (e.g., natural language understanding algorithms and/or machine learning algorithms) to automatically determine skills and/or skill levels on the basis of the ingested data. Based on the received data set comprising the plurality of role descriptions, the system may (e.g., algorithmically, with or without one or more inputs from a user such as user 110) generate data which links one or more roles to one or more entities. For example, the plurality of role descriptions in the data set may indicate an analyst role and a nurse role. The system may generate data indicating the analyst role is associated with Entity A and the nurse role is associated with Entity B, in the exemplary instance in which one or more analysts are employed by Entity A and one or more nurses are employed by entity B.

In some embodiment, data linking a role with one or more entities may be stored (e.g., on or in association with role library 152) in any suitable format. In some embodiments, the stored data indicating the association may indicate that a certain entity employs or is associated with one or more persons in a certain role—for example indicating information about the number of people in that role at the entity, the importance of that role at the entity, an organizational structure in which the role is disposed within the entity, temporal information about changes in the role over time at the entity, and/or information about one or more specific persons in that role at the entity. In some embodiments, role data linking a role to an entity may link the role to specific persons at the entity, such that the role data is associated with skill data and skill level data for one or more specific persons at the entity. Data for a certain role may be associated with one entity, with a plurality of entities, or with no entities.

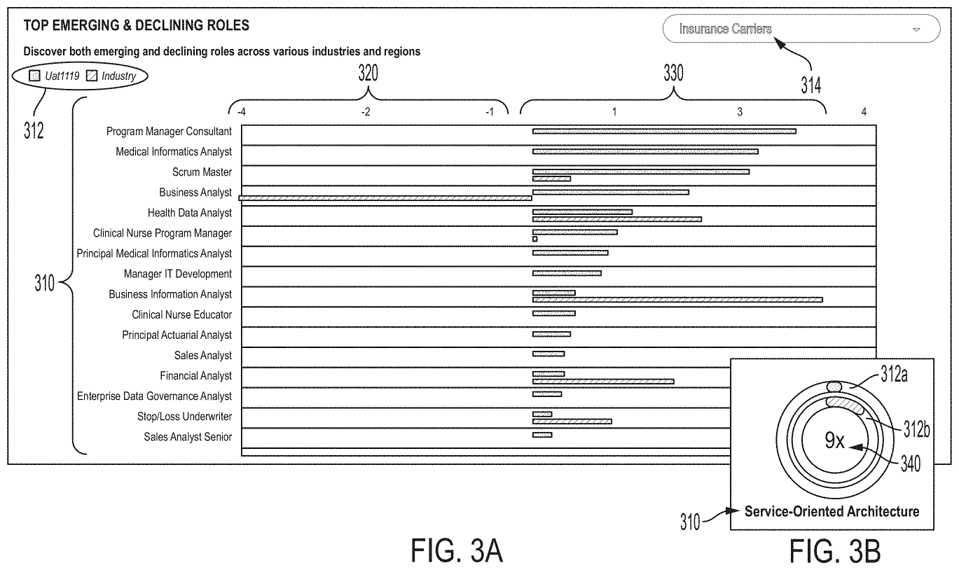

At block 206, in some embodiments, the system may cause a graphical user interface (GUI) comprising a visualization region to display on the display screen of a user's device. In some embodiments, the graphical user interface may comprise a visualization region configured to display one or more visualizations (e.g., interactive visualizations) for visualizing role data for one or more roles, one or more entities, one or more specific persons, and/or one or more industry sectors. The graphical user interface may comprise one or more affordances (e.g., icons, fields, menus, etc.) that can be used by a user of the graphical user interface to interact with data stored by (or accessible to) the system in order to cause the system to generate (and/or modify) and display one or more visualizations based on the data. In some embodiments, the user may be user 110, and the system may cause the GUI to be displayed on one or more screens of a user device of user 110. In some embodiments, the displayed graphical user interface may include, for example, one or more features shown and/or described below with reference to FIGS. 3A and 3B.

At block 208, in some embodiments, the system may receive, via the GUI, a first user input comprising an instruction to visualize role information for a set of one or more entities. For example, user 110 may execute an input via the GUI, as displayed on the user's device, that indicates a selection of one or more entities, one or more roles, and/or one or more skills. In some embodiments, a user may indicate entities for which to generate a visualization, for example visualizing a comparison of role data and/or skill data comparing the two entities. Additionally or alternatively, a user may indicate role data for which to generate a visualization, for example visualizing skill data (and/or skill level data) for one or more selected roles within one or more selected entities. Additionally or alternatively, a user may indicate skills for which to generate a visualization, for example visualizing skill data (and/or skill level data) for one or more selected roles and/or for one or more selected entities.

In some embodiments, the first user input may comprise an indication of a set of one or more entities for which the user wishes to visualize role information and/or skill information. In some embodiments, the indication of the set of one or more entities may involve the user clicking on an icon, typing into a field (e.g., search box), and/or scrolling to and selecting from a menu to select the selected entity (or entities). A user may select the user's own entity, a third-party entity with which the user is not associated, and/or a group of entities (e.g., a specified group of entities, an industry sector, or an entire industry). In some embodiments, the user may execute one or more inputs selecting a visualization type; in some embodiments, the system may automatically select one or more visualization types based on the user's selection of entities, roles, and/or skills.

At block 210, in some embodiments, the system may respond to receiving the first user input at block 208 by generating and causing display of one or more visualizations in the visualization region of the GUI, based on the data representing the associations of the plurality of roles indicated by the plurality of role descriptions with one or more of the plurality of entities indicated by the input. The generated and displayed visualization may represent one or more roles associated with the set of one or more indicated entities, and may indicate one or more skills and/or skill levels associated therewith. The system may cause the one or more visualizations to display in the visualization region of the GUI, for example as displayed on a display of the device of user 110 and/or as shown, by way of example, in FIGS. 3A and/or 3B. The generated visualizations may be based on some or all of the data representing the associations of a plurality of roles with one or more of a plurality of entities selected by the user. For example, the visualization may be generated, in whole or in part, based on the data generated by the system at block block 204. In some embodiments, the system may automatically (e.g., algorithmically) determine which visualizations to display based on the set of entities indicated in the first user input.

In some embodiments, a generated visualization may indicate distribution of roles within an entity, distribution and importance of one or more skills within one or more roles within an entity, and/or changes over time to any of the above. Because the data representing the one or more roles associated with the set of one or more entities may be generated based on job description data and/or job posting data, the generated visualizations may provide users of the system with one or more insights related to the effectiveness of one or more job postings belonging to an entity and/or to related or competing entities.

In some embodiments, the one or more visualizations may comprise a visualization of one or more temporal changes in roles for the set of one or more entities. For example, the one or more visualizations may include a plot of the number of employees holding certain roles within the set of one or more entities over a certain period of time. In some embodiments, the period of time over which the temporal changes in roles are displayed may be one or more years and/or one or more months. In some embodiments, the visualization of the temporal changes in roles may include a visualization of a percentage change.

In some embodiments, the one or more visualizations may comprise a visualization of the top emerging roles for the set of one or more entities. For example, the one or more visualizations may comprise a chart showing which roles gained employees at the highest rates (or which roles gained by highest absolute number of employees) over a certain period of time. In some embodiments, the one or more visualizations may comprise a visualization of the top declining roles for the set of one or more entities. For example, the one or more visualizations may include a chart showing which roles lost employees at the highest rates (or which roles lost by highest absolute number of employees) over a certain period of time. In some embodiments, the visualization of the top emerging and/or declining roles may display a quantitative comparison of role data between one entity and another entity, or between one entity and a set of entities (such as an industry sector average or an entire industry average).

In some embodiments, the one or more visualizations may comprise a visualization of a comparison of role prevalence between a first subset of the set of one or more entities and a second subset of the set of one or more entities. In some embodiments, the visualization of a comparison of role prevalence may include comparative ring diagrams and/or bar charts which display the prevalence of one or more roles in the first subset of entities compared to the prevalence of the same roles in the second subset of entities.

At block 212, in some embodiments, the system may receive, via the GUI, a second user input comprising an indication of a portion of the one or more displayed visualizations. In some embodiments, the second user input may comprise a the user clicking, tapping, highlighting, and/or hovering over a portion of the displayed visualization (and/or another graphical user interface object displayed on the GUI). In some embodiments, the displayed visualization may be an interactive visualization, such that one or more portions of the visualization may be selectable by a user (e.g., user 110) of the GUI on which the visualization is displayed in order to cause the system to modify/update the visualization in accordance with further user input. For example, a user may be able to click/tap/or hover over one or more elements of the visualization to cause popup information to be displayed overlaid on the visualization (wherein the popup information corresponds to the element of the visualization selected by the user), to zoom the visualization in to a portion of the visualization, and/or to cause the visualization to “drill down” by displaying additional information corresponding to to the element of the visualization selected by the user (and optionally hiding other information when the additional information is displayed).

At block 214, in some embodiments, the system may respond to receiving the second user input at block 212 by updating the displayed visualization in accordance with the second user input, for example by increasing a displayed precision in the visualization. In some embodiments, the update to the displayed visualization may include zooming in, zooming out, causing a popup to be overlaid on the visualization, and/or causing the visualization to “drill down” on a selected portion of the visualization. In some embodiments, a user may roll over a displayed portion of the visualization and cause an indication of more precise information (e.g., a numerical quantification) associated with the displayed portion of the visualization to be responsively displayed. In some embodiments, the update may comprise a change (e.g., an increase or a decrease) in a displayed precision of a role quantification, for example a percentage of employees within an organization who are in a selected role type.

FIG. 3A shows a GUI screen displaying a visualization of the top emerging and declining roles within a selected industry, according to some embodiments. The GUI may be caused to display on a screen of a user device by one or more processors included in a system for upskilling and digital asset management, for example by system 100 described above with reference to FIG. 1. In some embodiments, the visualization may be the visualization displayed at block 210 of method 200.

As shown, the visualization comprises a comparative bar chart comprising a vertical axis 310 which lists a plurality of roles. In some embodiments, the system may be configured to automatically (e.g., algorithmically) determine which roles to display along vertical axis 310 based on ingested role data and/or based on user input an entity selection, a role selection, and/or a skill selection. The comparative bar chart also includes a horizontal axis that is split into a negative horizontal half axis 320 and a positive horizontal half axis 330. Negative horizontal half axis 320 represents role declines while positive horizontal half axis 330 represents role emergences. The midline between negative horizontal half axis 320 and positive horizontal half axis 330 represents no change in a role for the depicted time window. If a role is emerging (e.g., if hiring for a role is increasing) within the represented entity, then the bar corresponding to that role will extend from the midline to the right, along positive horizontal half axis 330. If a role is declining (e.g., if hiring for a role is decreasing), then the bar corresponding to that role will extend from the midline to the left, along negative horizontal half axis 320. The length of a bar represents the degree to which a role has emerged or declined compared to other roles in the chart.

In some embodiments, the comparative bar chart may be configured to simultaneously display role trends for multiple entities. Each role along vertical axis 310 may have multiple bars corresponding to multiple entities; each individual bar may represent a change in the role within a given entity. Different entities may be distinguished on the bar chart by different visual indicators. Visual indicators may include colors and/or patterns. For example, if the comparative bar chart is simultaneously displaying data for Entity A and Entity B, the bars corresponding to Entity A may be blue while the bars corresponding to entity B may be red. This may allow the user to simultaneously compare role trends within a single entity and across several entities. The visualization may include an entity key 312 configured to display a list of entities whose role trends are displayed in the comparative bar chart along with the visual indicators corresponding to each displayed entity. In some embodiments, in addition to or alternatively to showing emerging/declining role trends for a single entity, the visualization may display trends for a group of entities, an industry sector, or an entire industry, for example by showing aggregated and/or averaged data across the group of entities. Data for a group of entities may be visualized in the same or similar manner as for a single entity. This may allow the user to compare role trends within their organization to the overall role trends within the industry to which their organization belongs.

As shown, in some embodiments, the user may choose which entities are displayed using an entity drop down menu 314. In some embodiments, the visualization may be updated in real time in response to the user selecting one or more entities, e.g., from drop-down menu 314.

In some embodiments, a user may hover over, tap on, or click on one or more of the bars in the visualization in order to cause more precise information to be displayed, e.g., a popup box indicating more precise information about a percentage increase or absolute number of roles added in the target time window for the role that has been selected by the user.

FIG. 3B shows a portion of a graphical user interface screen displaying a ring diagram for visualizing role prevalence. The ring diagram may constitute a visualization portion of a GUI, such as the visualization displayed at block 210 of method 200. It may be caused to display on a screen of a user device by one or more processors included in a system for upskilling and digital asset management, for example by system 100 described above with reference to FIG. 1.

As shown, the ring diagram comprises a label 310, an outer ring 312a, and an inner ring 312b. Label 310 may indicate a role for which the ring diagram displays role data. As shown, the ring diagram may include two (or more) concentric rings, where each ring may indicate role prevalence data and/or role trend data for a corresponding entity (or set of entities). The amount by which a ring is filled in may represent the prevalence of the indicated role within the corresponding entity (or, alternately, may represent an extent to which the role is emerging or declining within an organization). The multiple concentric rings may allow users to visually compare role prevalence across multiple entities, and may allow a user to easily hover a cursor over the different rings to cause popup or drill-down data to be selectively displayed as the user moves the cursor. In some embodiments, the system may be configured to display information related to role prevalence (e.g., a numerical quantification of role prevalence) when the user selects (e.g., hovers over) a portion of a ring.

In some embodiments, a ring diagram may include a multiplier 340 indicating a role prevalence ratio. For example, as shown, multiplier 340 reads “9×”. This may indicate that the role (here, “Service-Oriented Architecture”) is nine times as prevalent within the entity corresponding to inner ring 312b than it is within the entity corresponding to outer ring 312a. In some embodiments, hovering over the multiplier 340 may cause the multiplier to be displayed at a higher precision (e.g., by displaying one or more additional decimal points for the multiplier).

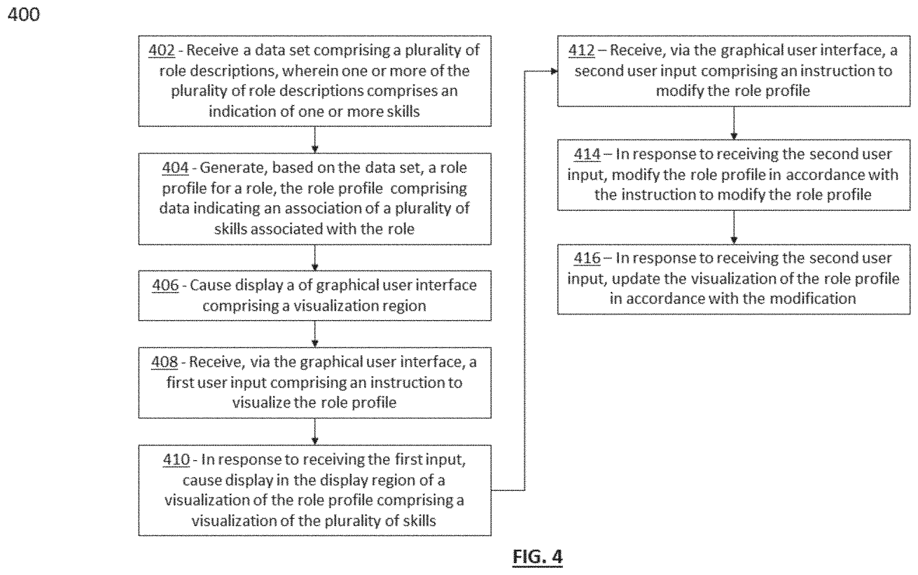

FIG. 4 shows a method 400 for generating and displaying role profiles (e.g., in a role library), according to some embodiments. Method 400 may be executed by one or more processors included in a system for upskilling and digital asset management, for example by system 100 (e.g., by upskilling and digital asset management engine 102) described above with reference to FIG. 1. As described below, method 400 may enable a user (e.g., user 110) of the system to view and interact with a graphical user interface that displays role profile information, wherein the role profile information includes information about skills and/or skill levels that are associated with a role corresponding to the role profile.

In some embodiments, at block 402, the system may receive a data set comprising a plurality of role descriptions. In some embodiments, block 402 may share any one or more characteristics in common with block 202, which is described above. In some embodiments, receiving role descriptions may include receiving explicit and/or implicit information about one or more skills that are associated with roles (and/or that are associated with one or more persons holding said roles). In some embodiments, the system may extract (e.g., algorithmically, using natural language understanding algorithms and/or machine learning algorithms) skill and/or skill level information regarding one or more roles from the received data set. Extracted skill information may indicate that a skill is associated with (e.g., is possessed by, or should be possessed by) persons holding said role. Extracted skill level information may indicate a skill level for a skill that is associated with (e.g., is possessed by, or should be possessed by) persons holding said role.

At block 404, in some embodiments, the system may generate a role profile for a role based on the data set received at block 402. For example, the system may extract skill and/or skill level information from the received data, and may generate and store a data structure representing a role profile, wherein the stored role profile data represents skill and skill level information for the represented role. In some embodiments, the role profile may comprise data indicating the level of importance of each of the one or more skills to the role. (In some embodiments, a skill level and an importance level for a skill may be separate concepts (though they may be related, e.g., derived from overlapping data), such that a role profile may store both skill level information for a skill and skill importance information for a skill. In some embodiments, the system may generate a role profile for a role automatically (e.g., algorithmically). Additionally or alternatively, the system may generate a role profile based on one or more user inputs. In some embodiments, the system may store the role profile in any suitable computer storage medium, such as in (or in association with) a database of role library 152 described above with reference to FIG. 1.

As described above, a role profile may in some embodiments correspond specifically to one entity (or specifically to one set of entities); in some embodiments, a role profiles may correspond generally to all entity using system 100. In some embodiments, a role profile may include information about a role that is applicable to all entities using the system. In these instances, for example, the same information about the role may be displayed and/or used with respect to any entity. In some embodiments, a role profile may include information about a role that is specifically applicable only to one entity or only to one set of entities. In these instances, for example, different information about a single role may be displayed and/or used by the system with respect to different entities. In some embodiments, separate role profile data structures for the same role may be stored for different entities. In some embodiments, a single role profile data structure may include different information that corresponds respectively to different respective entities, for example by including different skill information (skills for a role, skill prevalence for the role, target skill levels for the role, importance level for the skill for the role) for different entities.

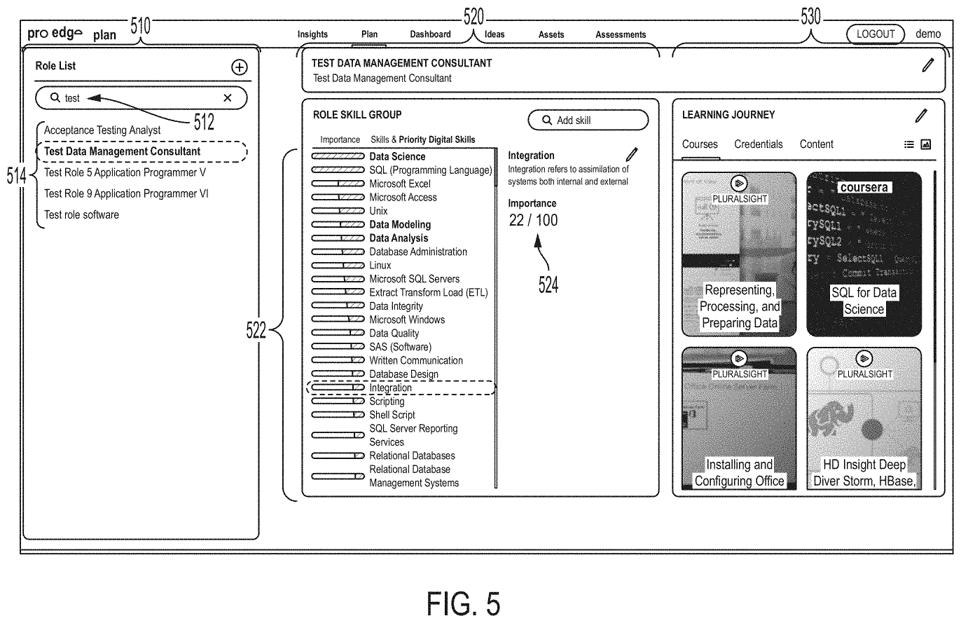

At block 406, in some embodiments, the system may cause a GUI comprising a visualization region to display on the display screen of the user's device. In some embodiments, the graphical user interface may comprise a visualization region configured to display one or more visualizations (e.g., interactive visualizations) for visualizing information associated with one or more role profiles. The graphical user interface may comprise one or more affordances (e.g., icons, fields, menus, etc.) that can be used by a user of the graphical user interface to interact with data stored by (or accessible to) the system in order to cause the system to generate (and/or modify) and display one or more visualizations based on the role profile data (and/or based on the underlying ingested data). In some embodiments, the user may be user 110, and the system may cause the GUI to be displayed on one or more screens of a user device of user 110. In some embodiments, the displayed graphical user interface may include, for example, one or more features shown and/or described below with reference to FIG. 5.

At block 408, in some embodiments, the system may receive, via the GUI, a first user input comprising an instruction to visualize a role profile. For example, a user (e.g., user 110) of the displayed GUI may execute an input via the GUI, for example by selecting one or more affordances displayed as part of the GUI. In some embodiments, the instruction to visualize the role profile may comprise the user typing the name of one or more roles, selecting an affordance associated with one or more role, and/or selecting one or more roles from displayed menu.

At block 410, in some embodiments, the system may respond to receiving the first user input at block 408 by generating and/or causing display of a visualization of the role profile, wherein the visualization is displayed in the visualization region of the GUI. The visualization of the role profile may comprise a visualization of (at least one of) the one or more skills associated with the role. In some embodiments, visualized skills (and/or associated skill levels and/or skill importance information) may be automatically (e.g., algorithmically) selected by the system for visualization. Additionally or alternatively, visualized skills (and/or associated skill levels and/or skill importance information) may be selected by the system based in whole or in part on one or more user inputs (e.g., the first user input, and/or one or more other user inputs) that explicitly or implicitly indicate one or more skills, skill levels, and/or skill importance information. For example, a user input may select certain skill levels for display, may indicate that most common skills for a role should be displayed, may indicate that most important skills for a role should be displayed, may indicate that the most advanced (e.g., highest skill level) skills for a role should be displayed, and/or may indicate whether skill level information and/or skill importance information should be displayed for one or more displayed skills. The system may configure the displayed visualization accordingly in response to any such indication made, via the GUI, by a user.

In some embodiments, the visualization of the one or more skills associated with the role may comprise a visualization of the relative importance of one or more of the displayed skills, for example by displaying a ranking of top skills according to prevalence (how common is the skill for persons holding said role), skill level (how advanced is the skill level for persons holding said role), and/or importance.

In some embodiments, after a role profile visualization is displayed, the user may be able to execute one or more inputs to modify or update the visualization, for example by causing different and/or additional information to be displayed (e.g., by “drilling down” or causing one or more popups to be displayed, as discussed above with respect to the visualization(s) of method 200).

Alternatively or additionally to allowing for modification of a visualization of a role profile, the system may allow a user to modify the role profile itself. That is, a user with sufficient privileges (e.g., user 110 of system 100) may be able to execute one or more inputs that cause the system to modify data stored for the role profile, such as by modifying skills associated with the role profile, skill levels associated with one or more skills for the role profile, skill importance for one or more skills associated with the role profile, and/or modifying one or more pieces of upskilling content and/or digital assets associated with the role profile. The system may be configured such that is receives instructions to modify the role profile, e.g., via a GUI displayed to the user, and responsively edits the role profile stored in (or in association with) user library 153 in accordance with the instructions received. In some embodiments, said instructions may be received via the same GUI that displays role profile information to a user; in some embodiments, said instructions may be received via a separate GUI. Below, blocks 412-416 describe an exemplary process for modifying a role profile.

At block 412, in some embodiments, the system may receive, via the GUI, a second user input comprising an instruction to modify the displayed role profile. In some embodiments, the instruction to modify the role profile may comprise an instruction to modify skills associated with the role profile (e.g., by adding or removing one or more skills), to modify skill levels associated with one or more skills for the role profile, to modify skill importance for one or more skills associated with the role profile, and/or to modify one or more pieces of upskilling content and/or digital assets associated with the role profile. In some embodiments, the second user input may comprise a user selecting an editing affordance (e.g., an editing icon) and selecting an affordance associated with one or more skills to be added or removed from a role profile. In some embodiments, the second input may comprise a user dragging-and-dropping a representation of one or more skills into and/or out of the visualization region to cause the represented skill to be linked to or unlinked with the role profile. In some embodiments, the second input may comprise a user adjusting one or more slider affordances to cause the system to adjust a skill level and/or skill importance of an associated skill. In some embodiments, in addition to being able to manually link and/or unlink a skill from a role profile, a user may be able to make manual adjustments to a skill prevalence—e.g., the number or percentage of persons in the represented role who hold the skill.

At block 414, in some embodiments, in response to receiving the second user input, the system may modify the role profile in accordance with the second user input. The system may cause data representing the role profile, for example as stored in role library 152, to be modified and/or augmented in accordance with the user input, such that an updated version of the role profile is stored for future access and/or visualization.

At block 416, in some embodiments, the system may update the displayed visualization of the role profile in accordance with the modification of the role profile described above with reference to block 414. In some embodiments, the update to the displayed visualization of the role profile may be made in real time (e.g., as a user executed the second user input, such as drag-and-drop inputs or slider-based inputs). In some embodiments, the visualization may be modified to add or remove one or more representations of one or more skills for the role profile, to adjust a visualization of a skill level, to adjust a visualization of a skill importance, add or remove a visualization indicating one or more pieces of upskilling content and/or one or more digital assets associated with the role profile. In some embodiments, in accordance with an adjustment to a skill prevalence, skill level, and/or skill importance associated with a role profile, the system may automatically adjust an order in which one or more skills are displayed in a visualization of the role profile (for example when the skills are displayed in a ranked order according to a criteria which has been adjusted in accordance with the second user input).

FIG. 5 shows a graphical user interface screen displaying a visualization of role profiles in a role library, according to some embodiments. A GUI including the GUI screen shown in FIG. 5 may be caused to be displayed on a user device by one or more processors included in a system for upskilling and digital asset management, for example by system 100 described above with reference to FIG. 1. In some embodiments, the GUI may be the GUI displayed at block 406 of method 400.

As shown, the GUI screen may include a role library portion 510, which may include a displayed list of roles 514 and a search field 512 that may accept user inputs that allow a user to search/filter the displayed list 514. The list 514 may display names of roles for which a role profile is stored by the system, for example by displaying a list of all (or some) of the role profiles that are stored in role library 152 of system 100. The GUI may be configured such that a user can select a role profile from the displayed list 514, such as by clicking or tapping on one or the displayed role titles. In some embodiments, clicking or tapping on a role title in list 514 may constitute a user input configured to cause the GUI to display a visualization of role data (including, e.g., associated skill data) for the corresponding role profile.

In some embodiments, when the user selects a role of interest (e.g., from list 514), the system may cause the GUI to display a role profile visualization 520 corresponding to the selected role. In the example shown in FIG. 5, the user has selected the “Test Data management Consultant” role from list 514, thereby causing role profile visualization 520 to be displayed. As shown, role profile visualization 520 comprises a skill list 522 associated with the depicted role profile. In some embodiments, the skills included in skill list 522 may be ordered by level of prevalence, importance, and/or skill level (e.g., target skill level for the skill). In the example shown, the displayed skills in list 522 are ranked by importance, and the importance level of each skill is visually indicated by the respective bars corresponding to each list item.

In some embodiments, displayed skill information may be interactive. For example, one or more user interface objects in role profile visualization 520 may be able to be selected by a user to cause display of additional corresponding information. In some embodiments, a user may click on or tap on a displayed skill in the role profile visualization, and the system may responsively cause additional information about the selected skill to be displayed. In the example shown, the user has clicked on the “integration” skill, which causes the system to cause display of skill importance quantification visualization 524, which shows a numerical quantification of the skill importance, and of a written definition of the skill. Importance level quantification visualization 524 may include a numerical score which indicates the skill's importance level relative to a maximum importance level.

In some embodiments, the GUI displaying the visualization of role profiles includes a learning journey panel 530. In some embodiments, learning journey panel 530 may be configured to display visual representations of upskilling content (e.g., courses, credentials, content, videos, training modules, articles, or other media content objects) and/or digital assets that are associated with the depicted role. Upskilling content and/or digital assets that are represented in panel 530 may be those that are linked to the role profile such that they are recommended (or required) for consumption by users in the represented role.

As shown in FIG. 5, the GUI screen may include various affordances (as represented by the pencil icons) allowing a user to edit content of one or more aspects of the depicted role profile. For example, a user with sufficient permissions may use the GUI to edit skill information and/or learning journey information for the depicted role profile, for example by adding or removing skills or by adding or removing upskilling content or digital assets.

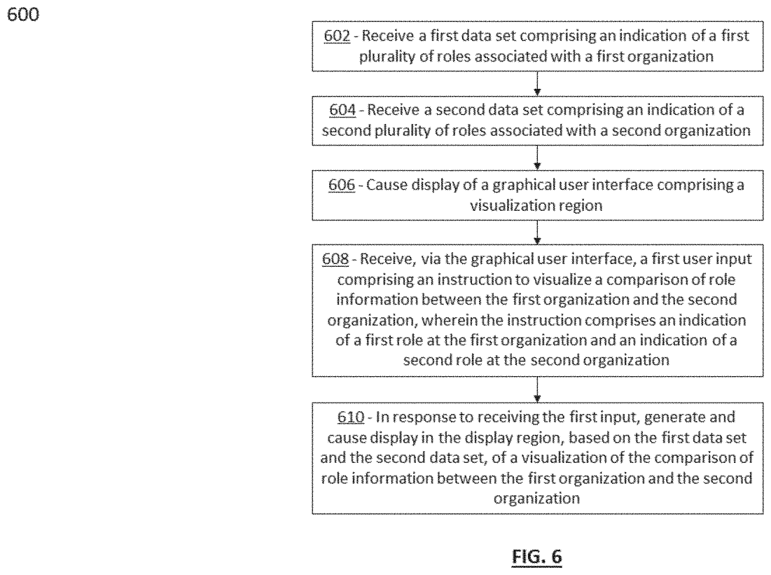

FIG. 6 shows a method 600 for visualizing role data for multiple entities, for example by comparatively visualizing skill data for different roles at different entities, according to some embodiments. Method 600 may be executed by one or more processors included in a system for upskilling and digital asset management, for example by system 100 (e.g., by upskilling and digital asset management engine 102) described above with reference to FIG. 1. As described below, method 600 may enable a user to generate and display a visualization for comparing roles at different companies, for example by comparing different skill information for roles at different entities. As described below, method 600 may enable a user to create visualizations that emphasize differences in roles corresponding to the same role profile across different organizations, such as by visualizing how different skills correspond differently to the same role (or related roles) across different organizations.

In some embodiments, at block 602, the system may receive a first data set comprising an indication of a first plurality of roles associated with a first entity. In some embodiments, at block 604, the system may receive a second data set comprising an indication of a second plurality of roles associated with a second entity. In some embodiments, the first and second data sets may be received separately from one another. In some embodiments, the first and second data sets may be received together, e.g., as part of a single data ingestion operation and/or as part of a single larger data set. If the data sets are received together, the system may parse the data to separate the two data sets and to generate and store information regarding the manner in which the roles correspond differently to the two different entities.

Receiving the first and/or second data set may comprise receiving, for example, an organizational chart representing an entity, ingesting job posting data pertaining to an entity, ingesting job description data pertaining to an entity, and/or ingesting social media information associated with an entity. In some embodiments, the first and/or second data set may comprise information indicating a set of skills associated with one or more roles. The skill information may include an indication of skills associated with persons holding a certain role within a company, including, e.g., current skill levels, target skill levels, and/or skill importance. In some embodiments, the skill information may be explicitly and/or implicitly indicated in the ingested data set(s); in the case of the skill information being implicitly indicated in the ingested data set(s), the system may apply one or more algorithms (with or without some human user intervention) to extract skill information from the ingested data set(s), for example using natural language processing and/or machine learning.

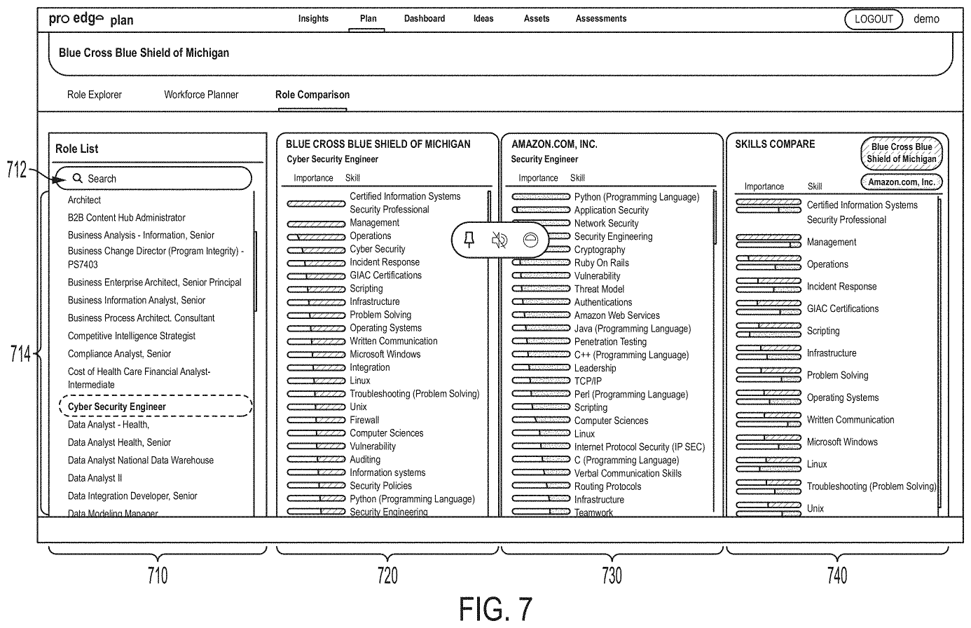

At block 606, the system may cause a GUI comprising a visualization region to display on the display screen of the user's device. In some embodiments, the graphical user interface may comprise a visualization region configured to display one or more visualizations (e.g., interactive visualizations) for visualizing information associated with role data (including associated skill data) at two or more entities. The graphical user interface may comprise one or more affordances (e.g., icons, fields, menus, etc.) that can be used by a user of the graphical user interface to interact with data stored by (or accessible to) the system in order to cause the system to generate (and/or modify) and display one or more visualizations based on the role data. In some embodiments, the user may be user 110, and the system may cause the GUI to be displayed on one or more screens of a user device of user 110. In some embodiments, the displayed graphical user interface may include, for example, one or more features shown and/or described below with reference to FIG. 7.

At block 608, in some embodiments, the system may receive, via the GUI, a first user input comprising an instruction to visualize a comparison of role information between the first entity and the second entity.

The user input may comprise a user selection, e.g., from a list or menu and/or by selecting one or more displayed graphical user interface objects, indicating selection of the first entity and the second entity.

The user input may comprise a user selection, e.g., from a list or menu and/or by selecting one or more displayed graphical user interface objects, indicating selection of a role at the first entity and of a role at the second entity. In some embodiments, the user input may indicate a single role to be used for both entities in the comparison. In some, embodiments, the user input may indicate different roles to be used for the two entities in the comparison. In some embodiments, the first role at the first entity and the second role at the second entity may be associated with a common role profile. In some embodiments, the first role at the first entity and the second role at the second entity may not be associated with a common role profile.

The user input may comprise a user selection, e.g., from a list or menu and/or by selecting one or more displayed graphical user interface objects, indicating selection of one or more skills to be visualized in the visualization. In some embodiments, the system may automatically (e.g., algorithmically) select one or more skills to visualize in the visualization, such as by selecting skills that have the highest prevalence and/or highest importance for one or more of the selected roles. In some embodiments, the user input may specify one or more criteria to be used in selecting skills to be visualized—e.g., visualize the most important skills for one entity (or the other); visualize the most prevalent skills for one entity (or the other); visualize only common skills across the roles for both compared entities; and/or visualize skills with the greatest differences in prevalence, target skill level, current skill level, and/or importance between the compared entities.

The user input may comprise one or more visualization preferences, such as by selecting one or more visualization types, visualization styles, and/or ranking criteria for information displayed in the visualization.

At block 610, in some embodiments, the system, upon receiving the first input, may generate a visualization of the comparison of role information between the first entity and the second entity. The visualization may be generated in accordance with the instructions indicated by the first input, including by selecting the indicated entities, indicated roles, and/or indicated skill information for visualization in the comparison, and including by generating and displaying the visualization in accordance with one or more visualization preferences indicated in the input.

In some embodiments, one or more aspects of the visualization may be automatically (e.g., algorithmically) configured by the system. For example, skills for visualization that correspond to one or more of the selected roles may be automatically selected, and an order for display of the skills in the visualization may be automatically selected.

In some embodiments, the visualization may include a visualization of skill data for the first entity and the second entity displayed in a side-by-side, interleaved, and/or overlaid manner, so as to facilitate visual comparison of the skill data for the two entities. In some embodiments, the visualized skill data may include a visualization of a respective skill importance level for various skills. In some embodiments, corresponding skills for each of the two entities may be displayed adjacent to one another, to facilitate easy visual comparison. In some embodiments, top skills (e.g., ranked by importance) may be displayed for each entity, such that the same skills are not necessarily displayed adjacent to one another for both entities.

In some embodiments, the GUI may provide the user with one or more options to edit the displayed visualization, such as by causing different or additional information to be displayed, by zooming the visualization, buy causing one or more popup visualizations to be displayed (e.g., overlaid on the visualization), and/or by causing the visualization to drill down to display additional and/or more precise information.

As shown, method 600 involves comparing role information between two entities. In some embodiments, method 600 may be adapted to compare role information between three or more entities. In some embodiments, method 600 may be adapted to compare role information for a group of entities (e.g., with visualized role and skill information aggregated and/or averaged), an industry sector, and/or an entire industry. A single entity may be compared against a sector or industry to allow the user to gain insights for benchmarking purposes.

FIG. 7 shows a GUI screen displaying a visualizations of role data for multiple entities, according to some embodiments. A GUI including the GUI screen shown in FIG. 7 may be caused to be displayed on a user device by one or more processors included in a system for upskilling and digital asset management, for example by system 100 described above with reference to FIG. 1. In some embodiments, the GUI may be the GUI displayed at block 606 of method 600.

As shown, the GUI screen may comprises a searchable role library portion 710, which may include search field 712 and a role list 714. Role library portion 710 may include any one or more features of role library portion 510 as described above with reference to FIG. 5. In some embodiments, the user may select, via role library 710, one or more roles to be compared between two entities. (In some embodiments, a user may make multiple role selections, for example selecting one role for one entity and another role for the other entity. In some embodiments, the user may make a single role selection for both entities. In some embodiments, the user may make a single role selection, and the system may automatically (e.g., algorithmically) select the closest matching role that is available for each entity to be included in the visualization.)

In some embodiments, when the user selects a role from role list 714, the GUI may display role information associated with the selected role (and/or with a closely related role). As shown, the GUI may display role information for a first entity in a first entity panel 720 and role information for a second entity in a second entity panel 730. In the example shown, the user has selected the “Cyber Security Engineer” role, and the system has been caused to display information for the “Cyber Security Engineer” role in panel 720 for one entity and for the “Security Engineer” role in panel 730 for another entity.

As shown, the displayed role information in panels 720 and 730 includes a list of skills associated respectively with the selected roles. In the example shown, the displayed skills in panels 720 and 730 are selected based on, and ranked in order of, highest importance for the skill to the respective role. Because the skills are ranked according to importance for each entity, the order of skills in panel 720 is not the same as the order of skills in panel 730. (In alternate embodiments, like skills could be displayed side-by-side in panels 720 and 730.) In some embodiments, the relative importance of skills in the skill list may be visually indicated by horizontal bars of varying length displayed for each skill.

As shown, the GUI screen further comprises skill comparison panel 740. Skill comparison panel 740 displays a list of skills associated with the selected role at both the first entity and the second entity, and includes a targeted comparison for skill information for each of the displayed skills. A targeted comparison may visualize a comparison of any suitable skill data for the selected skill. In the example shown, a comparison of relative importance for the compared entities is shown. Targeted comparisons visualizations may allow the user to easily and efficiently compare skill information for the same skill across two different entities.

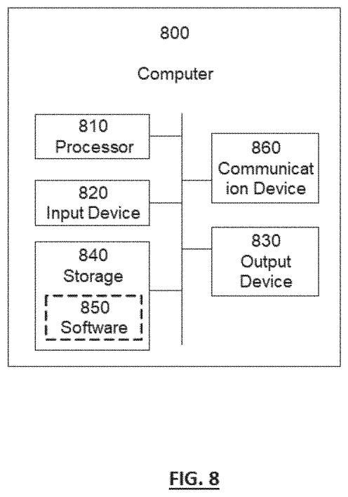

FIG. 8 shows a computer, in accordance with some embodiments. Computer 800 can be a component of an upskilling and digital asset management system according to the systems and methods described above, such as system 100 of FIG. 1. In some embodiments, computer 800 may execute one or more of the methods described herein, such as a method for visualizing role data and workforce data.

Computer 800 can be a host computer connected to a network. Computer 800 can be a client computer or a server. As shown in FIG. 9, computer 800 can be any suitable type of microprocessor-based device, such as a personal computer, workstation, server, or handheld computing device, such as a phone or tablet. The computer can include, for example, one or more of processor 810, input device 820, output device 830, storage 840, and communication device 860. Input device 820 and output device 830 can correspond to those described above and can either be connectable or integrated with the computer.

Input device 820 can be any suitable device that provides input, such as a touch screen or monitor, keyboard, mouse, or voice-recognition device. Output device 830 can be any suitable device that provides an output, such as a touch screen, monitor, printer, disk drive, or speaker.

Storage 840 can be any suitable device that provides storage, such as an electrical, magnetic, or optical memory, including a random access memory (RAM), cache, hard drive, CD-ROM drive, tape drive, or removable storage disk. Communication device 860 can include any suitable device capable of transmitting and receiving signals over a network, such as a network interface chip or card. The components of the computer can be connected in any suitable manner, such as via a physical bus or wirelessly. Storage 840 can be a non-transitory computer-readable storage medium comprising one or more programs, which, when executed by one or more processors, such as processor 810, cause the one or more processors to execute methods described herein.

Software 850, which can be stored in storage 840 and executed by processor 810, can include, for example, the programming that embodies the functionality of the present disclosure (e.g., as embodied in the systems, computers, servers, and/or devices as described above). In some embodiments, software 850 can include a combination of servers such as application servers and database servers.

Software 850 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 800 can implement any operating system suitable for operating on the network. Software 850 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A system for visualizing role data, the system comprising one or more processors configured to cause the system to:
receive a data set comprising a plurality of role descriptions,
generate, based on the data set, data representing associations of a plurality of roles indicated by the plurality of role descriptions with one or more of a plurality of entities;
cause display of a graphical user interface comprising a visualization region;
receive, via the graphical user interface, a first user input comprising an instruction to visualize role information for a set of one or more of the entities, wherein the first user input comprises an indication of the set of one or more of the entities; and
in response to receiving the first input, generate and cause display in the display region, based on the data representing the associations of a plurality of roles indicated by the plurality of role descriptions with one or more of a plurality of entities, of one or more visualizations representing one or more roles associated with the set of one or more of the entities.

2. The system of claim 1, wherein receiving the data set comprises receiving data from one or more sources selected from: a job posting data source; a job description data source, a data source associated with a single entity of the plurality of entities; a data source associated with more than one of the plurality of entities; and a social media data source.

3. The system of claim 1, wherein receiving the data set comprises one or more methods of receipt selected from: performing automated scraping of one or more data sources, receiving a batch upload; receiving the data set according to a predetermined schedule; receiving the data set in response to a predefined trigger condition; and receiving an update to previously-received data.

4. The system of claim 1, wherein generating the data representing the associations of the plurality of roles with one or more of the plurality of entities comprises applying one or more automated algorithms.

5. The system of claim 1, wherein the indication of the set of one or more entities comprises an indication of one or more selected from: an entity associated with the first user, an entity not associated with the first user, and an industry sector.

6. The system of claim 1, wherein the one or more visualizations representing one or more roles associated with the set of one or more of the entities comprise one or more visualizations selected from the following:
a visualization of one or more temporal changes in roles for the set of one or more entities;
a visualization of top emerging roles for the set of one or more entities;
a visualization of top declining roles for the set of one or more entities; and
a visualization of a comparison of role prevalence between a first subset of one or more entities in the set of entities and a second subset of one or more entities in the set of entities.

7. The system of claim 6, wherein display of the visualization of the comparison of role prevalence comprises display of:
a first portion visualizing a first role quantification associated with the first subset of entities;
a second portion visualizing a second role quantification associated with the second subset of entities; and
a third portion visualizing a first comparison quantification of a difference between the first role quantification and the second role quantification.

8. The system of claim 7, wherein:
the first portion comprises a first ring diagram indicating a first role percentage;
the second portion comprises a second ring diagram indicating a second role percentage; and
the third portion comprises an indication of a multiple comparing the first role percentage and the second role percentage, wherein the third portion is displayed in an interior space of the first ring diagram and the second ring diagram.

9. The system of claim 7, wherein the one or more processors are configured to cause the system to:
detect a second user input comprising an indication of the first portion; and
in response to detecting the second user input, update the first portion to increase a displayed precision of the first role quantification.

10. The system of claim 1, wherein the one or more roles are automatically selected by the system for visualization based on the indication of the set of one or more of the entities via the first user input.

11. The system of claim 1, wherein:
one or more of the plurality of role descriptions comprises an indication of a plurality of skills;
the one or more processors are further configured to cause the system to:
generate, based on the data set, data representing associations of the plurality of skills with one or more of the plurality of entities;
receive, via the graphical user interface, a third user input comprising an instruction to visualize skill information for the set of one or more of the entities, wherein the third user input comprises an indication of the set of one or more of the entities; and
in response to receiving the third user input, generate and cause display in the display region, based on the data representing the associations of the plurality of skills with one or more of the plurality of entities, of one or more visualizations representing one or more skills associated with the set of one or more of the entities.

12. The system of claim 11, wherein the one or more visualizations representing one or more skills associated with the set of one or more of the entities comprise one or more visualizations selected from the following:
a visualization of one or more temporal changes in skills for the set of one or more entities;
a visualization of top emerging skills for the set of one or more entities;
a visualization of top declining skills for the set of one or more entities; and
a visualization of a comparison of skill prevalence between a third subset of one or more entities in the set of entities and a fourth subset of one or more entities in the set of entities.

13. The system of claim 12, wherein display of the visualization of the comparison of skill prevalence comprises display of:
a fourth portion visualizing a first skill quantification associated with the third subset of entities;
a fifth portion visualizing a second skill quantification associated with the fourth subset of entities; and
a sixth portion visualizing a second comparison quantification of a difference between the first skill quantification and the second skill quantification.

14. The system of claim 13, wherein:
the fourth portion comprises a third ring diagram indicating a first skill percentage;
the fifth portion comprises a fourth ring diagram indicating a second skill percentage; and
the sixth portion comprises an indication of a multiple comparing the first skill percentage and the second skill percentage, wherein the sixth portion is displayed in an interior space of the third ring diagram and the fourth ring diagram.

15. The system of claim 13, wherein the one or more processors are configured to cause the system to:
detect a fourth user input comprising an indication of the fourth portion; and
in response to detecting the fourth user input, update the fourth portion to increase a displayed precision of the first skill quantification.

16. The system of claim 11, wherein the one or more skills are automatically selected by the system for visualization based on the indication of the set of one or more of the entities via the first user input.

17. A method for visualizing role data, the method performed at a system comprising one or more processors, the method comprising:
receiving a data set comprising a plurality of role descriptions,
generating, based on the data set, data representing associations of a plurality of roles indicated by the plurality of role descriptions with one or more of a plurality of entities;
causing display of a graphical user interface comprising a visualization region;
receiving, via the graphical user interface, a first user input comprising an instruction to visualize role information for a set of one or more of the entities, wherein the first user input comprises an indication of the set of one or more of the entities; and
in response to receiving the first input, generating and causing display in the display region, based on the data representing the associations of a plurality of roles indicated by the plurality of role descriptions with one or more of a plurality of entities, of one or more visualizations representing one or more roles associated with the set of one or more of the entities.

18. A non-transitory computer-readable storage medium storing instructions for visualizing role data, wherein the instructions are executable by a system comprising one or more processors to cause the system to:
receive a data set comprising a plurality of role descriptions,
generate, based on the data set, data representing associations of a plurality of roles indicated by the plurality of role descriptions with one or more of a plurality of entities;
cause display of a graphical user interface comprising a visualization region;
receive, via the graphical user interface, a first user input comprising an instruction to visualize role information for a set of one or more of the entities, wherein the first user input comprises an indication of the set of one or more of the entities; and
in response to receiving the first input, generate and cause display in the display region, based on the data representing the associations of a plurality of roles indicated by the plurality of role descriptions with one or more of a plurality of entities, of one or more visualizations representing one or more roles associated with the set of one or more of the entities.

19. A system for providing a role library, the system comprising one or more processors configured to cause the system to:
receive a data set comprising a plurality of role descriptions, wherein one or more of the plurality of role descriptions comprises an indication of one or more skills;
generate, based on the data set, a role profile for a role, the role profile comprising data indicating an association of a plurality of skills associated with the role;
cause display a of graphical user interface comprising a visualization region;
receive, via the graphical user interface, a first user input comprising an instruction to visualize the role profile; and
in response to receiving the first input, cause display in the display region of a visualization of the role profile comprising a visualization of the plurality of skills.

20. The system of claim 19, wherein receiving the data set comprises receiving data from one or more sources selected from: a job posting data source; a job description data source, a data source associated with a single entity of the plurality of entities; a data source associated with more than one of the plurality of entities; and a social media data source.

21. The system of claim 19, wherein receiving the data set comprises one or more methods of receipt selected from: performing automated scraping of one or more data sources, receiving a batch upload; receiving the data set according to a predetermined schedule; receiving the data set in response to a predefined trigger condition; and receiving an update to previously-received data.

22. The system of claim 19, wherein generating the role profile comprises applying one or more automated algorithms.

23. The system of claim 19, wherein the instruction to visualize the role profile comprises one or more selected from: typing of the name of the role, selection of a user-interface affordance associated with the role, and selection of the role via a menu of a role library.

24. The system of claim 19, wherein:
the role profile comprises data quantifying an importance of one or more of the plurality of skills associated with the role; and
the visualization of the role profile comprises a visualization of the data quantifying the importance of the one or more of the plurality of skills associated with the role.

25. The system of claim 24, wherein the one or more of the plurality of skills are automatically selected by the system for visualization based on the data set comprising the plurality of role descriptions.

26. The system of claim 24, wherein the visualization comprises display of a subset of skills that are determined to be most important to the role.

27. The system of claim 19, wherein the one or more processors are further configured to cause the system to:
receive, via the graphical user interface, a second user input comprising an instruction to modify the role profile; and
in response to receiving the second input:
modify the role profile in accordance with the instruction to modify the role profile; and
update the visualization of the role profile in accordance with the modification.

28. The system of claim 27, wherein the instruction to modify the role profile comprises an instruction to modify skills associates with the role by performing one or more of the following: adding a new skill to the role profile, removing a skill from the role profile, and modifying data quantifying an importance of a skill in the role profile.

29. A method for providing a role library, the method performed at a system comprising one or more processors, the method comprising:
receiving a data set comprising a plurality of role descriptions, wherein one or more of the plurality of role descriptions comprises an indication of one or more skills;
generating, based on the data set, a role profile for a role, the role profile comprising data indicating an association of a plurality of skills associated with the role;
causing display a of graphical user interface comprising a visualization region;
receiving, via the graphical user interface, a first user input comprising an instruction to visualize the role profile; and
in response to receiving the first input, causing display in the display region of a visualization of the role profile comprising a visualization of the plurality of skills.

30. A non-transitory computer-readable storage medium storing instructions for providing a role library, wherein the instructions are executable by a system comprising one or more processors to cause the system to:
receive a data set comprising a plurality of role descriptions, wherein one or more of the plurality of role descriptions comprises an indication of one or more skills;
generate, based on the data set, a role profile for a role, the role profile comprising data indicating an association of a plurality of skills associated with the role;
causing display a of graphical user interface comprising a visualization region;
receive, via the graphical user interface, a first user input comprising an instruction to visualize the role profile; and
in response to receiving the first input, cause display in the display region of a visualization of the role profile comprising a visualization of the plurality of skills.

31. A system for visualizing workforce data, the system comprising one or more processors configured to cause the system to:
receive a first data set comprising an indication of a first plurality of roles associated with a first organization;
receive a second data set comprising an indication of a second plurality of roles associated with a second organization;
cause display of a graphical user interface comprising a visualization region;
receive, via the graphical user interface, a first user input comprising an instruction to visualize a comparison of role information between the first organization and the second organization, wherein the instruction comprises an indication of a first role at the first organization and an indication of a second role at the second organization; and
in response to receiving the first input, generate and cause display in the display region, based on the first data set and the second data set, of a visualization of the comparison of role information between the first organization and the second organization.

32. The system of claim 31, wherein receiving the first data set comprising the indication of the first plurality of roles associated with the first organization comprises one or more methods of receipt selected from: receiving an organizational chart representing the first organization, ingesting job-posting data pertaining to the first organization, ingesting job-description data pertaining to the first organization, and ingesting social media information associated with the first organization.

33. The system of claim 31, wherein receiving the second data set comprising the indication of the second plurality of roles associated with the second organization comprises one or more methods of receipt selected from: receiving an organizational chart representing the second organization, ingesting job-posting data pertaining to the second organization, ingesting job-description data pertaining to the second organization, and ingesting social media information associated with the second organization.

34. The system of claim 31, wherein the first role at the first organization and the second role at the second organization are each associated with a common role profile.

35. The system of claim 31, wherein the first role at the first organization and the second role at the second organization are not associated with a common role profile.

36. The system of claim 31, wherein:
the first data set and the second data set comprise information indicating respective skills associated with one or more of the roles of the first and second pluralities of roles; and
the visualization represents a comparison of a first set of skills associated with the first role in the first organization against a second set of skills associated with the second role in the second organization.

37. The system of claim 36, wherein the visualization indicates a first quantification of a first importance of one or more of the skills of the first set of skills and a second quantification of a second importance of one or more of the skills of the second set of skills.

38. The system of claim 37, wherein the system is further configured to determine a display order for one or more of the first set of skills and the second set of skills based on one or more of the first quantification of the first importance and the second quantification of the second importance.

39. The system of claim 37, wherein the system is configured to select one or more of the first set of skills and the second set of skills for display based on one or more of the first quantification of the first importance and the second quantification of the second importance.

40. The system of claim 39, wherein the system selects skills for visualization based on a difference between the first quantification of the first importance and the second quantification of the second importance.

41. The system of claim 36, wherein the visualization aligns representations of matching skills across the first set of skills in the second set of skills with one another.

42. A method for visualizing workforce data, the method performed at a system comprising one or more processors, the method comprising:
receiving a first data set comprising an indication of a first plurality of roles associated with a first organization;
receiving a second data set comprising an indication of a second plurality of roles associated with a second organization;
causing display of a graphical user interface comprising a visualization region;
receiving, via the graphical user interface, a first user input comprising an instruction to visualize a comparison of role information between the first organization and the second organization, wherein the instruction comprises an indication of a first role at the first organization and an indication of a second role at the second organization; and
in response to receiving the first input, generating and causing display in the display region, based on the first data set and the second data set, of a visualization of the comparison of role information between the first organization and the second organization.

43. A non-transitory computer-readable medium storing instructions for visualizing workforce data, wherein the instructions are executable by a system comprising one or more processors to cause the system to:
receive a first data set comprising an indication of a first plurality of roles associated with a first organization;
receive a second data set comprising an indication of a second plurality of roles associated with a second organization;
cause display of a graphical user interface comprising a visualization region;
receive, via the graphical user interface, a first user input comprising an instruction to visualize a comparison of role information between the first organization and the second organization, wherein the instruction comprises an indication of a first role at the first organization and an indication of a second role at the second organization; and
in response to receiving the first input, generate and cause display in the display region, based on the first data set and the second data set, of a visualization of the comparison of role information between the first organization and the second organization.
